(19) United States
(12) Patent Application Publication
(10) Pub. No.: US 2026/0000485 A1
(43) Pub. Date: Jan. 1, 2026

(54) METHODS AND SYSTEMS FOR DETERMINING RESTORATIVE TOOTH PARAMETERS

(71) Applicant: Align Technology, Inc., San Jose, CA (US)

(72) Inventors: Alexander KULINICH, Nizhegorodskaya (RU); Boris Aleksandrovich VYSOKANOV, Moscow (RU); Anton CHEKMENEV, Frankfurt am Main (DE); Maria LELYUK, Vladivostok (RU); Elena AGILINA, Holmdel, NJ (US); Vladislav Andreevich MIRYAHA, Moscow (RU); Dmitry Yurievich CHEKH, Moscow (RU)

(21) Appl. No.: 19/253,609

(22) Filed: Jun. 27, 2025

Related U.S. Application Data
(60) Provisional application No. 63/665,220, filed on Jun. 27, 2024.

(51) Int. Cl. A61C 7/00; A61C 7/08; G06T 19/20

(52) U.S. Cl. CPC A61C 7/002; A61C 7/08; G06T 19/20; G06T 2200/24; G06T 2210/21; G06T 2210/41; G06T 2219/2004

(57) ABSTRACT

System, methods, and apparatus for determining a width and position of a patient's restored teeth are disclosed. Teeth that undergo a restorative process may change in size (compared to original tooth dimensions). Dental data is extracted from a three-dimensional (3D) digital model that is generated based on a dental treatment plan. The width and/or position of the patient's restored teeth are determined with a solution to an optimization problem using the extracted dental data.

### CLAIM OF PRIORITY

This patent application claims priority to U.S. Provisional Patent Application No. 63/665,220, titled “METHODS AND SYSTEMS FOR DETERMINING RESTORATIVE TOOTH PARAMETERS,” and filed on Jun. 27, 2024, herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Orthodontic and dental treatments using a series of patient-removable appliances (e.g., “aligners”) are very useful for treating a variety of patients. Treatment planning is typically performed in conjunction with the dental professional (e.g., dentist, orthodontist, dental technician, etc.), by manipulating a model of the patient's teeth from an initial configuration (initial tooth positions) to a final configuration (final tooth positions) and then dividing the treatment into a number of intermediate stages (steps). These steps may correspond to individual appliances that may be worn sequentially, with or without additional interventions (e.g., interproximal reductions, extractions, etc.). Once a dental treatment plan is finalized, the series of aligners may be manufactured corresponding to the dental treatment plan.

A dental treatment plan may include one or more teeth that will receive some restorative treatment. In some cases, the restorative treatment may affect a width of the tooth receiving restorative treatment. Any changes to tooth widths within a dental arch may affect tooth spacing and position.

### SUMMARY OF THE DISCLOSURE

The systems and methods described herein relate generally to analysis of dental treatment planning, and more particularly to the determination and viewing of a dental arch that includes one or more teeth receiving a restorative treatment corresponding to a dental treatment plan. For example, described herein are apparatuses, systems, and methods for estimating a location and width a patient's teeth that are associated with a restorative treatment. Tooth restorations can affect tooth widths, tooth heights, tooth color, and the like. In some cases, a tooth restoration can change a final or predicted final position that was determined based on a dental treatment plan.

In some examples, the position and width of a restored tooth may be determined by a solution to an optimization problem. In general, the optimization problem can receive, as inputs, various dental parameters and determine restored tooth widths and positions through a solution of the optimization problem. The solution of the optimization problem may also include tooth positions, interproximal gaps, and the like of unrestored teeth included within a patient's dental arch.

Any of the apparatuses described herein may include a processor; and a memory that includes instructions, which when executed, cause the processor to execute the following steps: access or receive a final position three-dimensional (3D) digital dental model based on a dental treatment plan, and a list of one or more teeth that are to receive a restorative treatment, determine a final arch width and a plurality of final tooth widths from the final position 3D digital dental model; compute to solve an optimization problem by determining a restorative tooth center and a restorative tooth width for each of the one or more teeth in the list of one or more teeth to receive a restorative in which the solution to the optimization problem optimizes for at least: a restorative overlap, a restorative contact, and a restorative symmetry, and assign the restorative tooth center and the restorative tooth width to the restorative for each of the one or more teeth in the list of one or more teeth to receive the restorative.

In general, in any of the apparatuses, the restorative overlap may include coverage of the restorative over each of the one or more teeth to receive the restorative. In some examples, the restorative contact may include contact between the restorative and neighboring teeth and/or neighboring restoratives. In any of the apparatuses described herein, the restorative symmetry may include symmetry between the restorative and one or more teeth of a same type as the tooth receiving the restorative in the final position 3D digital dental model.

In any of the apparatuses described herein, the instructions may be further configured to cause the processor to display, in a user interface, the final position 3D digital dental model including the restorative for each of the one or more teeth in the list of one or more teeth to receive a restorative and receiving one or more user modifications thereto and adjusting the restorative according to the one or more user modifications thereto.

In some examples, the instructions are further configured to build the restorative for each of the one or more teeth in the list of one or more teeth to receive a restorative. In some aspects, the instructions may be further configured to cause the processor to build the restorative by outputting a digital model of the restorative for each of the one or more teeth in the list of one or more teeth to receive a restorative, and one or more synthetic images of the final position 3D digital dental model including the restorative for each of the one or more teeth in the list of one or more teeth to receive the restorative.

In any of the apparatuses described herein, the instructions may be further configured to cause the processor to build the restorative by outputting a specifications file including measurements for the restorative for each of the one or more teeth in the list of one or more teeth to receive the restorative.

In some examples, the instructions are further configured to receive a restorative model for at least one of the one or more teeth in the list of one or more teeth to receive the restorative, and where the instructions are further configured to cause the processor to optimize the optimization problem using the restorative model.

In any of the apparatuses described herein, the instructions are further configured to compute to solve the optimization problem using weights for each of the restorative overlap, the restorative contact, and the restorative symmetry. In some examples, the instructions are further configured to receive from a user interface, weights for one or more of the restorative overlap, a restorative contact, and a restorative symmetry from the user.

In any of the apparatuses described herein, the instructions are further configured to compute to solve the optimization problem in which the optimization problem also optimizes for a midline rule, where tooth widths for central teeth borders a target midline point. In some examples, the instructions are further configured to compute to solve the optimization problem in which the restorative overlap includes a range of interproximal spaces between teeth.

Any of the apparatus described herein may include a processor, and a memory that includes instructions, which when executed, cause the processor to execute the following steps: access or receive a final position three-dimensional (3D) digital dental model based on a dental treatment plan, and a list of one or more teeth that are to receive a restorative treatment, determine a final arch width and a plurality of final tooth widths from the final position 3d digital dental model, compute to solve an optimization problem by determining a restorative tooth center and a restorative tooth width for each of the one or more teeth in the list of one or more teeth to receive a restorative in which the solution to the optimization problem optimizes for at least restorative overlap may include coverage of the restorative over each of the one or more teeth to receive the restorative, restorative contact may include contact between the restorative and neighboring teeth and/or neighboring restoratives, and restorative symmetry may include symmetry between the restorative and one or more teeth of a same type as the tooth receiving the restorative in the final position 3D digital dental model, assign the restorative tooth center and the restorative tooth width to the restorative for each of the one or more teeth in the list of one or more teeth to receive the restorative; and building the restorative for each of the one or more teeth in the list of one or more teeth to receive a restorative.

Any of the methods disclosed herein may include accessing or receive a final position three-dimensional (3D) digital dental model based on a dental treatment plan, and a list of one or more teeth that are to receive a restorative treatment, determining a final arch width and a plurality of final tooth widths from the final position 3D digital dental model; computing to solve an optimization problem by determining a restorative tooth center and a restorative tooth width for each of the one or more teeth in the list of one or more teeth to receive a restorative in which the solution to the optimization problem optimizes for at least: a restorative overlap, a restorative contact, and a restorative symmetry; and assigning the restorative tooth center and the restorative tooth width to the restorative for each of the one or more teeth in the list of one or more teeth to receive the restorative

A non-transitory computer-readable storage medium may include instructions that, when executed by one or more processors of a device, cause the device to perform operations comprising accessing or receiving a final position three-dimensional (3D) digital dental model based on a dental treatment plan, and a list of one or more teeth that are to receive a restorative treatment, determining a final arch width and a plurality of final tooth widths from the final position 3d digital dental model, computing to solve an optimization problem by determining a restorative tooth center and a restorative tooth width for each of the one or more teeth in the list of one or more teeth to receive a restorative in which the solution to the optimization problem optimizes for at least: a restorative overlap, a restorative contact, and a restorative symmetry, and assigning the restorative tooth center and the restorative tooth width to the restorative for each of the one or more teeth in the list of one or more teeth to receive the restorative.

Any of the apparatuses described herein may include a processor configured to access or receive a final position dental model based on a dental treatment plan, determine dental information based on the final position dental model, access or receive a list of one or more teeth to receive a restorative treatment; access or receive one or more optimization targets, optimize widths and locations of teeth on the list of one or more teeth based on the dental information, the list of one or more teeth, and one or more optimization targets; and assign restorative widths and locations of teeth on the list of one or more teeth based on the optimized widths and locations. In any of the apparatuses described herein, the dental information can include tooth widths, dental arch length, tooth positions with respect to a dental arch, or a combination thereof. In some examples, the one or more optimization targets include a user selection of a restorative model for use with at least one tooth on the list of teeth. Each restorative model can include a material thickness, a height, a shape, or a combination thereof. In some examples, the user selected restorative model is scaled.

In any of the apparatuses described herein, the restorative widths may be based on weighted optimization targets, where weights of the optimization targets are determined by a user. In any of the apparatuses described herein, the restorative widths are based at least in part on mesial-to-distal tooth widths and interproximal spaces included in the dental information.

In any of the apparatuses described herein, the one or more optimization targets include a planned length of a dental arch in accordance with the dental treatment plan. In some examples, the one or more optimization targets include a tooth symmetry target, where tooth widths of contralateral teeth are selected to be similar.

In any of the apparatuses described herein, the one or more optimization targets can include a midline rule, where tooth widths for central teeth borders a target midline point.

In any of the apparatuses described herein, the processor may be further configured to render a 3D digital model of a dental arch based the restorative widths and locations of teeth on the list of one or more teeth. The one or more optimization targets include a range of acceptable interproximal spaces between teeth. The one or more optimization targets include an amount of overlap between two or more teeth.

A non-transitory computer-readable storage medium is disclosed that may include instructions that, when executed by one or more processors of a device, cause the device to perform operations comprising accessing or receiving a final position dental model based on a dental treatment plan, determining dental information based on the final position dental model; accessing or receiving a list of one or more teeth to receive a restorative treatment, accessing or receiving one or more optimization targets; optimizing widths and locations of teeth on the list of one or more teeth based on the dental information, the list of one or more teeth, and one or more optimization targets, and assigning restorative widths and locations of teeth on the list of one or more teeth based on the optimized widths and locations.

Any of the methods disclosed herein may include accessing or receiving a final position dental model based on a dental treatment plan, determining dental information based on the final position dental model; accessing or receiving a list of one or more teeth to receive a restorative treatment, accessing or receiving one or more optimization targets, optimizing widths and locations of teeth on the list of one or more teeth based on the dental information, the list of one or more teeth, and one or more optimization targets; and assigning restorative widths and locations of teeth on the list of one or more teeth based on the optimized widths and locations.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a diagram illustrating one variation of a dental computing environment.

FIG. 2 is a block diagram of one example of a restorative width module.

FIG. 3 shows an example 3D dental model of a patient's dental arch.

FIG. 4 is a diagram showing an example tooth width optimization.

FIG. 5 shows additional output that may be provided by the dental arch optimization engine of FIG. 2.

FIG. 6 is a flowchart showing an example method for determining width of a patient's restored teeth (teeth that received a restorative treatment) based on a final position.

FIG. 7 is a flowchart showing another example method for determining a width and/or location of a patient's restored teeth.

FIG. 8 is a flowchart showing another example method for determining a width of a patient's restored teeth.

FIG. 9 shows a block diagram of a device that may be one example a device configured to perform one or more operations associated with the computing environment of FIG. 1.

### DETAILED DESCRIPTION

In general, these methods and apparatuses may be used at one or more parts of a dental computing environment, including as part of an intraoral scanning system, doctor system, treatment planning system, patient system, and/or fabrication system. In particular, these methods and apparatuses may be used as part of a treatment planning system, for example, to determine an accurate (in some cases initial) location of a patient's teeth. The initial location may be used to determine a final location for one or more of the patient's teeth based on a treatment plan. The treatment plan may be optimized (modified) based on updated dental scans.

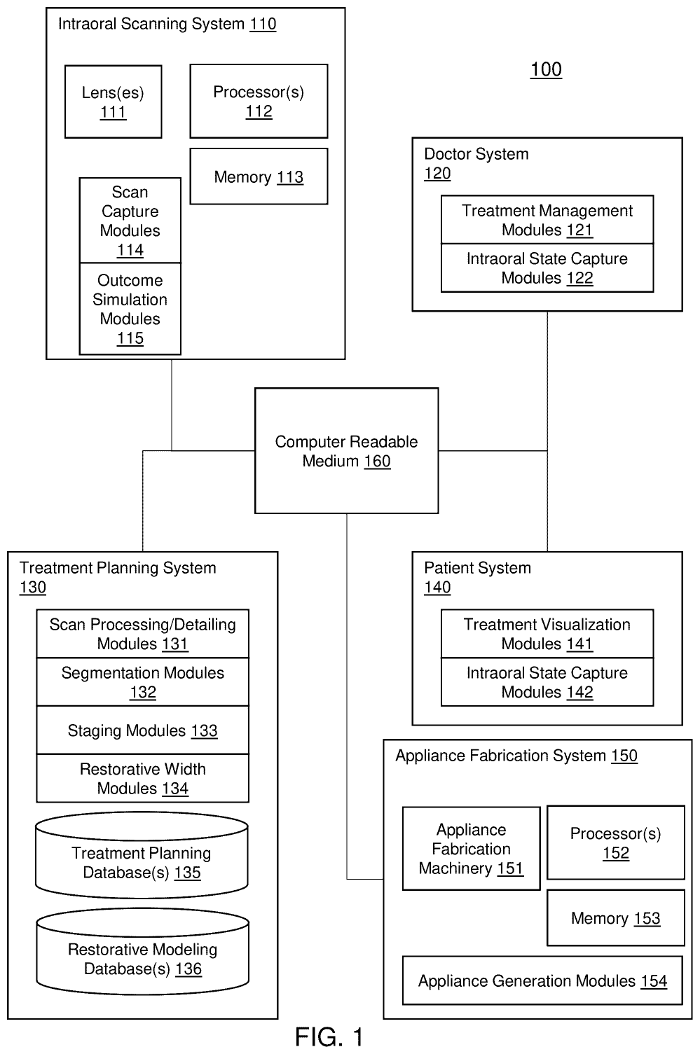

FIG. 1 is a diagram illustrating one variation of a dental computing environment 100 that may generate one or more orthodontic (dental) treatment plans specific to a patient and fabricate dental appliances that may accomplish the treatment plan to treat the patient, under the direction of a dental professional. The example dental computing environment 100 shown in FIG. 1 includes an intraoral scanning system 110, a doctor system 120, a treatment planning system 130, a patient system 140, an appliance fabrication system 150, and computer-readable medium 160. In some variations the dental computing environment (sometimes referred to as a dental computing system) 100 may include just one or a subset of these systems (which may also be referred to as sub-systems of the overall system 100). Further, one or more of these systems may be combined or integrated with one or more of the other systems (sub-systems), such as, e.g., the treatment planning system 130 and the doctor system 120 may be part of a remote server accessible by a doctor interface. The computer-readable medium 160 may be divided between all or some of the systems (subsystems); for example, the treatment planning system 130 and the appliance fabrication system 150 may be part of the same sub-system and may be on a computer-readable medium 160. Further, each of these systems may be further divided into sub-systems or components that may be physically distributed (e.g., between local and remote processors, etc.) or may be integrated.

An intraoral scanning system may include an intraoral scanner as well as one or more processors for processing images. For example, the intraoral scanning system 110 can include lens(es) 111, processor(s) 112, a memory 113, scan capture modules 114, and outcome simulation modules 115. In general, the intraoral scanning system 110 can capture one or more images of a patient's dentition. Use of the intraoral scanning system 110 may be in a clinical setting (doctor's office or the like) or in a patient-selected setting (the patient's home, for example). In some cases, operations of the intraoral scanning system 110 may be performed by an intraoral scanner, dental camera, cell phone or any other feasible device.

The lens(es) 111 include one or more lenses and optical sensors to capture reflected light, particularly from a patient's dentition. The scan capture modules 114 can include instructions (such as non-transitory computer-readable instructions) that may be stored in the memory 113 and executed by the processor(s) 112 to control the capture of any number of images of the patient's dentition.

As mentioned, in some examples the methods and apparatuses described herein for generating a 3D digital model including one or more teeth may be part of, or accessible by, the intraoral scanning system 110, computer-readable medium 160 and/or treatment planning system 130.

For example, the outcome simulation modules 115, which may be part of the intraoral scanning system 110, can include instructions that simulate final tooth positions (e.g., a predicted configuration of teeth) based on a treatment plan. In some cases, the outcome simulation modules 115 can include instructions that simulate tooth positions using images or other scan data from a dental scan

Any of the component systems or sub-systems of the dental computing environment 100 may access or use the patient's dental information including scan data, three-dimensional (3D) dental models, and/or treatment plans generated by the methods and apparatuses described herein. For example, the doctor system 120 may include treatment management modules 121 and intraoral state capture modules 122 that may access or use patient scan data and/or 3D dental models. The doctor system 120 may provide a “doctor facing” interface to the computing environment 100. The treatment management modules 121 can perform any operations that enable a doctor or other clinician to manage the treatment of any patient. In some examples, the treatment management modules 121 may provide a visualization and/or simulation of the patient's dentition with respect to a treatment plan. For example, the doctor system 120 may include a user interface for the doctor that allows the doctor to manipulate and view a patient's 3D dental model, including a 3D dental model corresponding to a final position of teeth in accordance with the treatment plan.

The intraoral state capture modules 122 can provide images of the patient's dentition to a clinician through the doctor system 120. The images may be captured through the intraoral scanning system 110 and may also include images of a simulation of tooth movement based on a treatment plan.

In some examples, the treatment management modules 121 can enable the doctor to modify or revise a treatment plan. The doctor system 120 may include one or more processors configured to execute any feasible non-transitory computer-readable instructions to perform any feasible operations described herein.

Alternatively or additionally, the treatment planning system 130 may include any of the methods and apparatuses described herein, and/or may determine a mapping between dental scans of a patient that are displaced in time. The treatment planning system 130 may include scan processing/detailing modules 131, segmentation modules 132, staging modules 133, restorative width modules 134, treatment planning database(s) 135 and restorative modeling database(s) 136. In general, the treatment planning system 130 can determine a treatment plan for any feasible patient. The scan processing/detailing modules 131 can receive or obtain dental scans (such as scans from the intraoral scanning system 110) and can process the scans to “clean” them by removing scan errors and, in some cases, enhancing details of the scanned image. In some implementations, the scan processing/detailing modules 131 can generate a 3D digital dental model using scan data from the intraoral scanning system 110.

The treatment planning system 130 may include a segmentation system that segments a model into separate components. For example, the treatment planning system 130 may include a segmentation modules 132 that can segment a dental model (such as a 3D dental model) into separate parts including separate teeth, gums, jaw bones, and the like. In some cases, the dental models may be based on scan data from the scan processing/detailing modules 131.

The staging modules 133 may determine different stages a dental treatment plan. Each stage may correspond to a different dental aligner. In some examples, the staging modules 133 may also determine a final position (also referred to as a target position) of the patient's teeth, in accordance with a treatment plan. Thus, the staging modules 133 can determine some or all of a patient's dental treatment plan. In some examples, the staging modules 133 can simulate movement of a patient's teeth in accordance with the different stages of the patient's treatment plan. In some examples, the dental treatment plan may be stored in one or more treatment planning database(s) 135.

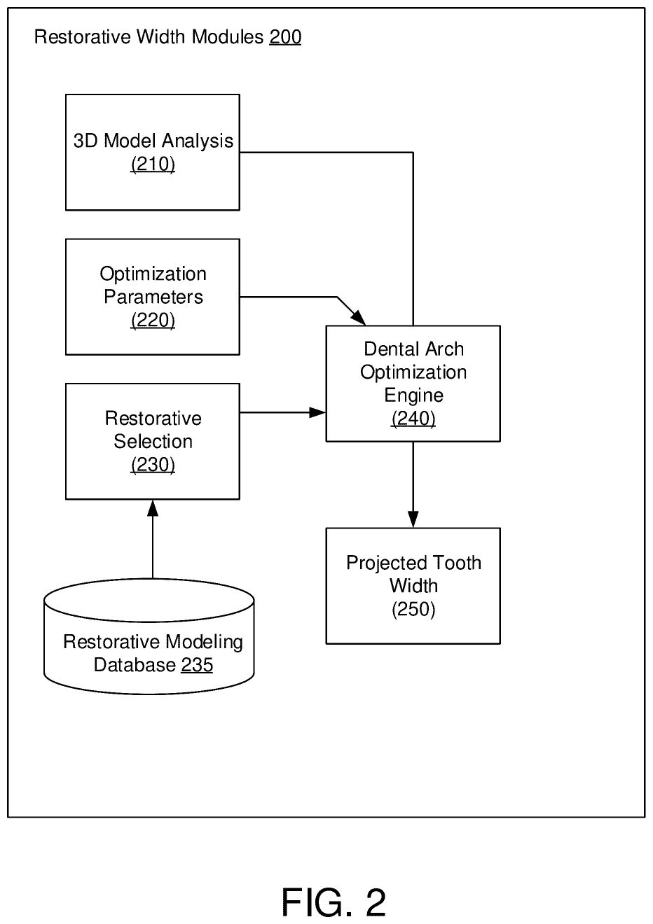

The restorative width modules 134 can perform any operations that enable a doctor or other clinician to determine the tooth width of one or more of the patient's teeth that may undergo a restorative treatment and are also included in a dental treatment plan. In some examples, the restorative width modules 134 may determine or receive one or more optimization parameters. Optimization parameters may provide guidance and in some cases may be dental treatment goals for the patient. The restorative width modules 134 may determine optimal tooth widths for restored and unrestored teeth, particularly when the teeth have been moved into a final position in accordance with a dental treatment plan. In some examples, the restorative width modules 134 may generate and display a 3D model of the patient's dental arch that includes images of the restored teeth. In some aspects, the restorative width modules 134 can use one or more models of restored teeth to determine the tooth width of the patient's teeth. For example, data from different types and styles or teeth and associated restorations can be used to determine tooth width. Restored tooth model data may be saved within, and recovered from, the restorative modeling database(s) 136. More details regarding the determining tooth widths is described herein with respect to FIG. 2.

The patient system 140 can include treatment visualization modules 141 and intraoral state capture modules 142. In general, the patient system 140 can provide a “patient facing” interface to the computing environment 100. The treatment visualization modules 141 can enable the patient to visualize how an orthodontic treatment plan has progressed and also visualize a predicted outcome (e.g., a final position of teeth).

In some examples, the patient system 140 can capture dentition scans for the treatment visualization modules 141 through the intraoral state capture modules 142. The intraoral state capture modules 142 can enable a patient to capture his or her own dentition through the intraoral scanning system 110. Although not shown here, the patient system 140 can include one or more processors configured to execute any feasible non-transitory computer-readable instructions to perform any feasible operations described herein.

The appliance fabrication system 150 can include appliance fabrication machinery 151, processor(s) 152, memory 153, and appliance generation modules 154. In general, the appliance fabrication system 150 can directly or indirectly fabricate aligners to implement any feasible dental treatment plan. In some examples, the dental treatment plan may be stored in the treatment planning database(s) 135.

The appliance fabrication machinery 151 may include any feasible implement or apparatus that can fabricate any suitable dental aligner. The appliance generation modules 154 may include any non-transitory computer-readable instructions that, when executed by the processor(s) 152, can generate one or more design files that can correspond to stages determined by the staging modules 133. In turn, the one or more design files may be used to build or fabricate one or more dental aligners. In some examples, the appliance fabrication machinery 151 can use the design files to produce the one or more dental aligners. The memory 153 may store data or instructions for use by the processor(s) 152. In some examples, the memory 153 may temporarily store a treatment plan, dental models, or intraoral scans.

The computer-readable medium 160 (sometimes referred to as a non-transitory computer-readable storage medium) may include some or all of the elements described herein with respect to the dental computing environment 100. The computer-readable medium 160 may include non-transitory computer-readable instructions that, when executed by a processor, can provide the functionality of any device, machine, or module described herein.

FIG. 2 is a block diagram of one example of a restorative width module 200. The restorative width module 200 may be wholly or partially included within the restorative width module 134 of FIG. 1. In other implementations, the restorative width module 200 may be included within any other system or sub-system of FIG. 1. The restorative width module 200 may include a 3D model analysis module 210, an optimization parameters module 220, a restorative selection module 230, a restorative modeling database 235, a dental arch optimization engine 240, and a projected tooth width module 250. In general, the restorative width module 200 can determine the tooth widths of one or more teeth included within a patient's dental arch, particularly when one or more teeth are planning to receive a restorative treatment. The position of the patient's teeth within the dental arch may be based on a dental treatment plan. In some examples, tooth widths may begin with data determined from a 3D model of the patient's teeth in a final position according to a dental treatment plan. In some cases, the tooth widths may be determined with an optimization solver driven or guided by one or more user selected optimization parameters. The optimization parameters may be preferences or design goals selected by a user.

The 3D model analysis module 210 determines and/or extracts dental data from a 3D digital model. In some aspects, the 3D digital model may be a 3D model of a patient's teeth based on a final position simulation of a dental treatment plan. In some cases, the 3D model analysis module 210 determines a length of a dental arch. The 3D model analysis module 210 can also determine tooth measurements of each tooth such as a location of tooth centers and the widths of teeth. In some examples, the width of teeth may be a mesial to distal distance, in some cases along an axis of the tooth. The 3D model analysis module 210 can also determine spaces included between teeth.

The optimization parameters module 220 determines or receives one or more parameters or design goals that may be taken into consideration when determining teeth width. In general, the optimization parameters may be considered as inputs to an optimization operation that seeks to determine an optimal tooth width of teeth receiving a restorative treatment. These tooth widths, along with the tooth widths of unrestored teeth may be used to generate a view (e.g., simulate) a final position of the patient's teeth.

In some examples, an optimization parameter can include an acceptable amount of tooth overlap. Tooth overlap describes how much a first tooth can overlap a second tooth. Furthermore, one of the overlapping teeth may be a restored tooth. Tooth overlap may be described in millimeters.

Another example of an optimization parameter can be a contact target. Contact targets can describe interproximal spaces or tooth contact. In some cases, neighboring restored teeth should contact each other. Thus, a distance between a left border of a right tooth and a right border of a left tooth should be approximately zero millimeters. In the case where a restored tooth is a terminal tooth (a tooth at either end of the dental arch) then the terminal tooth should touch (contact) the end of the dental arch.

Another example of an optimization parameter is a symmetry target. A symmetry target may specify that teeth of the same dental type (contralateral teeth) should have the same tooth width. The symmetry target may affect the tooth width of a restored tooth.

Another example of an optimization parameter may include a midline rule or preference. The midline rule may target a position of restored central (middle) teeth so that a corresponding tooth borders a target midline point. Other optimization parameters not discussed here are possible.

The restorative selection module 230 may enable a user to select a type or style of restorative treatment that may be applied to selected or targeted teeth. Restorative treatments can vary based on tooth type, tooth location, tooth shape, and the like. The restorative selection module 230 enables a user to select a restorative type, shape, etc., and apply the selection to any tooth in the dental arch. In some examples, the restorative selection module 230 enables a user to select a restorative treatment from the restorative modeling database 235. In some aspects, the restorative modeling database 235 can include a variety of predefined restorative models that vary in shape, restoration thickness, width, and the like.

The dental arch optimization engine 240 receives data from the 3D model analysis module 210, the optimization parameters module 220 and the restorative selection module 230 to determine a final position of the patient's teeth. In particular, the dental arch optimization engine 240 can determine the tooth widths of the patient's teeth, including teeth that are to receive a restorative treatment. The dental arch optimization engine 240 can also generate (render) a view of a 3D dental model that includes the determined tooth widths.

The dental arch optimization engine 240 can solve (determine) tooth widths for the patient's dental arch. In some implementations, the dental arch optimization engine 240 can implement a non-linear optimization solver to determine feasible tooth widths from some or all of the data received from other modules. Thus, the dental arch optimization engine 240 can determine an optimized tooth width of teeth within the dental arch, particularly teeth which receive some type of restorative treatment.

Because a restorative treatment can have an additional degree of freedom (width of the restoration), the restorative treatment may be selected to provide a pleasing aesthetic outcome, for example having a high level of symmetry, overlap, or the like. The dental arch optimization engine 240 may enable a doctor or clinician to visualize a final result of a dental treatment plan, including those plans that have teeth that receive some restorative treatment.

Notably, the operations performed by, or associated with the restorative width module 200 provide a technical solution to a technical problem. Determining an optimal tooth width of teeth undergoing a restorative treatment and generating a view of a 3D dental model including the teeth that have received a restorative treatment is a technical problem rooted in computer technology. Determining tooth widths, particularly of teeth undergoing a restorative treatment may be comparatively difficult. In some cases, the sheer number of variables that are considered to determine tooth widths may make a determination of tooth widths arduous and time consuming. In addition, the technical solution provided by the restorative width module 200 may provide a solution that is sufficiently efficient, particularly compared to a “brute force” method of trying different values of data inputs to provide tooth widths which are symmetric, have acceptable overlap or interproximal spaces, or the like.

The operations described herein provide a solution for a problem rooted in computer technology to overcome a problem specifically associated with determining tooth widths of teeth undergoing a restorative treatment and displaying information and/or images that include the restored teeth.

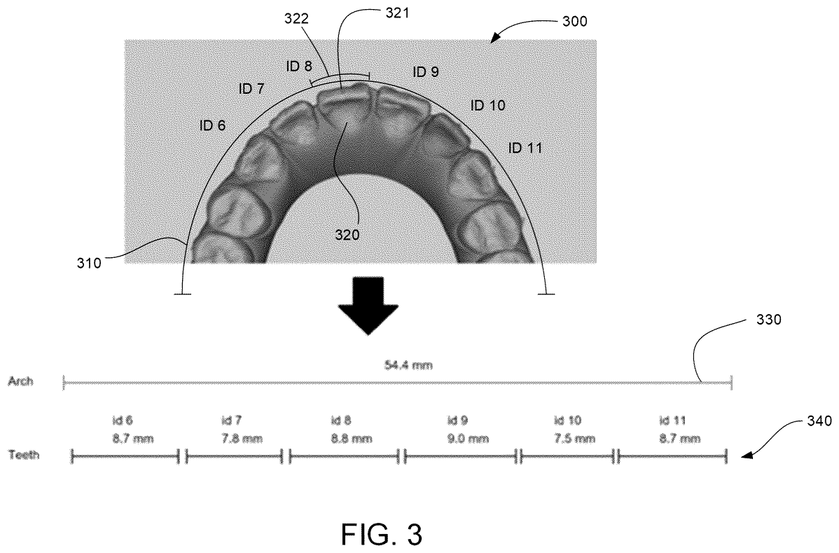

FIG. 3 shows an example 3D dental model of a patient's dental arch 300. The dental arch 300 may illustrate the patient's teeth in a position determined by a final position that is based on a dental treatment plan. Although the dental arch 300 is an upper dental arch, the dental arch may also be a lower dental arch (not shown). The dental arch 300 can include any feasible number of teeth.

The dental arch 300 may be described by a dental arch length 310. As shown, the dental arch length 310 can describe a distance that includes all the teeth disposed on the dental arch 300 as well as any spaces between teeth.

Each tooth in the dental arch 300 may be described with a position on the dental arch 300. In addition, each tooth may be described with a tooth width. In some examples, the tooth width may be a mesial-to-distal distance measured along the dental arch. In some other examples, the mesial-to-distal distance may be measured along an axis of the tooth. For example, tooth 320 may include a central a tooth center 321 that can locate the tooth 320 along the dental arch 300. The tooth 320 includes a tooth width 322 that may be a mesial-to-distal distance.

The 3D model analysis module 210 of FIG. 2 can determine (extract) dental data a 3D dental model. For example, the 3D model analysis module 210 can determine a length 330 of the dental arch 300. In addition, the 3D model analysis module 210 can determine individual tooth widths and spaces. Example tooth widths 340 are shown here corresponding to teeth in the dental arch 300.

In the example of FIG. 3, there may be one or more teeth that have been selected to receive a restorative treatment. For example teeth 6-11 may have been selected to receive a restorative treatment. As such, the width of teeth 6-11 may change as the widths are optimized responsive to design goals and/or optimization parameters. As described herein the widths may be optimized by the restorative width modules 134 of FIG. 1 and/or the restorative width module 200 of FIG. 2.

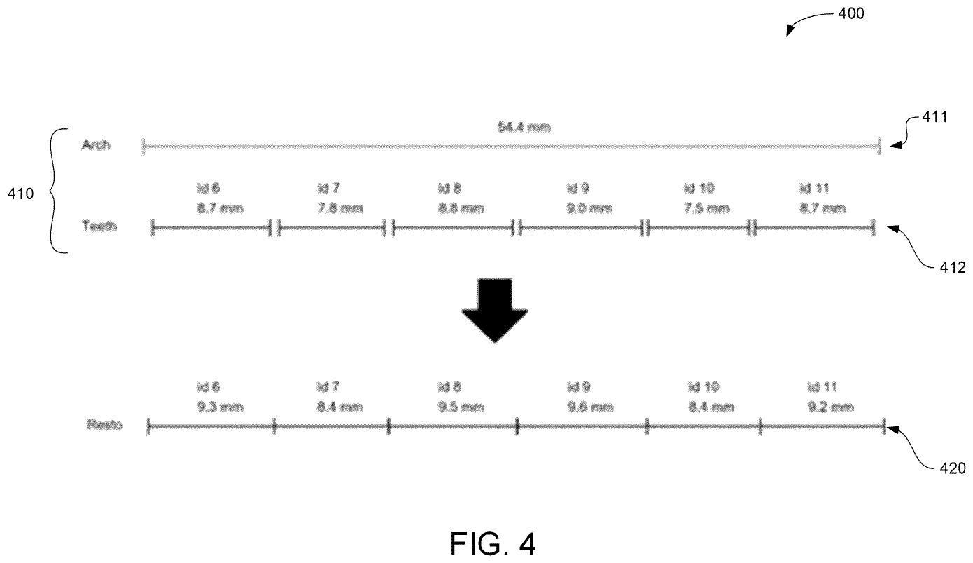

FIG. 4 is a diagram showing an example tooth width optimization 400. In some examples, the dental arch optimization engine 240 of FIG. 2 can receive dental data 410. The dental data 410 (which may be determined by the 3D model analysis module 210) may include a dental arch length 411 and individual tooth widths 412. A user may indicate to the dental arch optimization engine 240 that teeth 6-11 will receive a restorative treatment. Thus, the tooth widths of teeth 6-11 may be modified and/or optimized.

In some examples, the dental arch optimization engine 240 can use the dental data 410, as well as other optimization parameters as described herein, to determine tooth widths of the patient's teeth in the dental arch. Thus, the dental arch optimization engine 240 may generate the tooth widths 420.

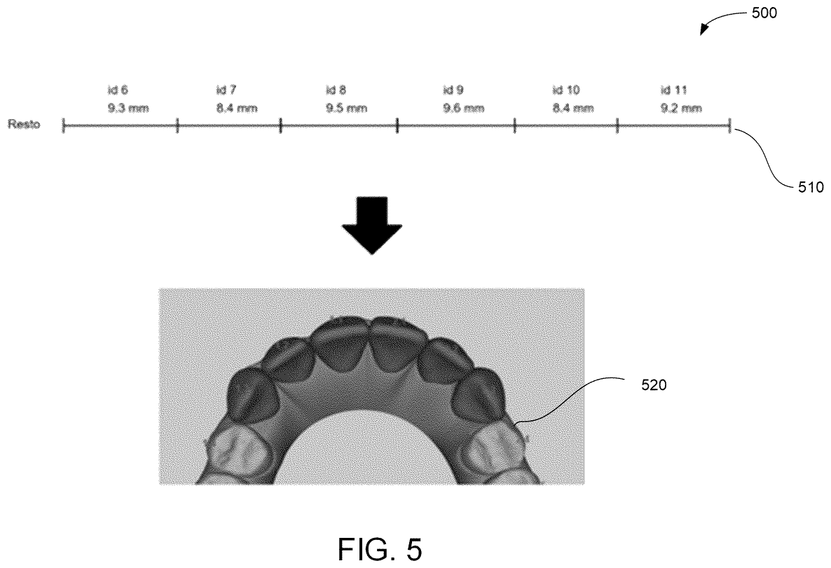

FIG. 5 shows additional output 500 that may be provided by the dental arch optimization engine 240 of FIG. 2. As described with respect to FIG. 4, the dental arch optimization engine 240 can generate tooth widths 510. (In FIG. 5, the tooth widths 510 are similar to the tooth widths 420 of FIG. 4, although any feasible tooth widths are possible.) The dental arch optimization engine 240 may generate a 3D model that reflects the optimized tooth widths. For example, the dental arch optimization engine 240 can generate 3D model 520 where the teeth widths of the 3D model 520 can correspond to the tooth widths 510.

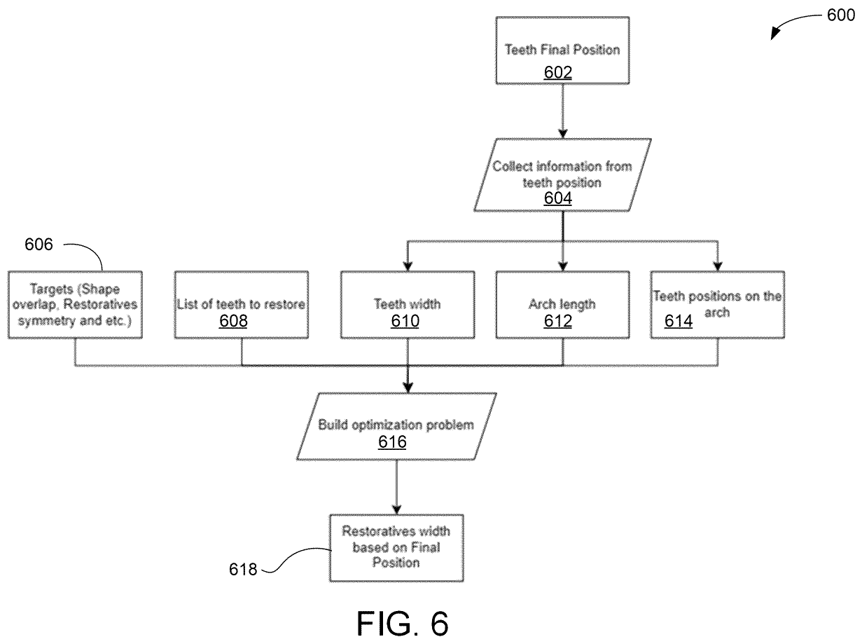

FIG. 6 is a flowchart showing an example method 600 for determining width and/or position of a patient's restored teeth (teeth that received a restorative treatment) based on a final position. Some examples may perform the operations described herein with additional operations, fewer operations, operations in a different order, operations in parallel, and some operations differently. The method 600 is described below with respect to the system 100 of FIG. 1 and/or the restorative width module 200 of FIG. 2., however, the method 600 may be performed by any other suitable system or device.

The method 600 begins in block 602 as final position information is obtained or received. In some examples, the final position information may include a 3D digital model of the patient's dentition. In some examples, the 3D digital model can include both upper and lower dental arches, however, in some other examples the final position information may include only the upper or the lower dental arch.

Next in block 604, information is collected from the final position information received in block 602. For example, the 3D model analysis module 210 can receive or obtain a 3D digital model and determine teeth width 610, dental arch length 612 and/or tooth positions on the dental arch 614. In some examples, the tooth position information can include tooth center information, particularly tooth centers with respect to the dental arch. In some examples, the collected information can also include space information describing spaces between teeth on the dental arch.

In block 608, a user, clinician, or the like can indicate the teeth on the dental arch that are to receive a restorative treatment. Not all teeth on the dental arch may require restoration, thus the user or other clinician can indicate which teeth will be restored.

In block 606, the 3D model analysis module 210 can obtain or receive one or more optimization parameters (also referred to as optimization targets) which can be used to determine the tooth width of teeth in the patient's dental arch, particularly teeth that are selected to receive a restorative treatment. In some examples, the optimization parameters can include tooth overlap, symmetry target, a midline rule, desired interproximal spacing, or any other feasible design target. In some examples, the optimization parameters can include a restorative model that has been selected for a tooth that will receive a restorative treatment. The restorative model can include tooth shape, tooth width, restorative thickness, and the like.

Data and information from blocks 606, 608, 610, 612, and 614 may be combined to build an optimization problem in block 616. The optimization problem may determine an optimum restored tooth width. In some implementations, the optimization problem is solved by the dental arch optimization engine 240. The dental arch optimization engine 240 may include a non-linear optimization solver that can receive and operate on the data and information from blocks 606, 608, 610, 612, and 614 and determine an optimized tooth width of restored teeth. In some aspects, the data and information used to solve the optimization problem can be weighted, thereby prioritizing some data or aspects over others.

For example, any feasible number of factors (f) may be used by the non-linear optimization solver. If there are F factors f, then the factors may generically be referred to as fᵢ, where i goes from 0 to F. In addition, each factor fᵢ may be weighted such that any factor may contribute more or less to the optimization. If the optimization problem is expressed as a function OPT(fᵢ) where fᵢ is any feasible optimization factor and wᵢ is an arbitrary weighting factor, then

$$OPT ( {f}_{i} ) = {w}_{0} {f}_{0} + {w}_{1} {f}_{1} + {w}_{2} {f}_{2} + … + {w}_{F} {f}_{F} \qquad ( eq . 1 )$$

In block 618, the restorative widths of the teeth based on the final position is determined. The optimization problem built (or determined) in block 616 may be solved to determine optimal tooth widths of restored teeth, in positions based on a final position of a dental treatment plan. Notably, the optimization solution may be based on a final position from a dental treatment plan since the final position information received at block 602.

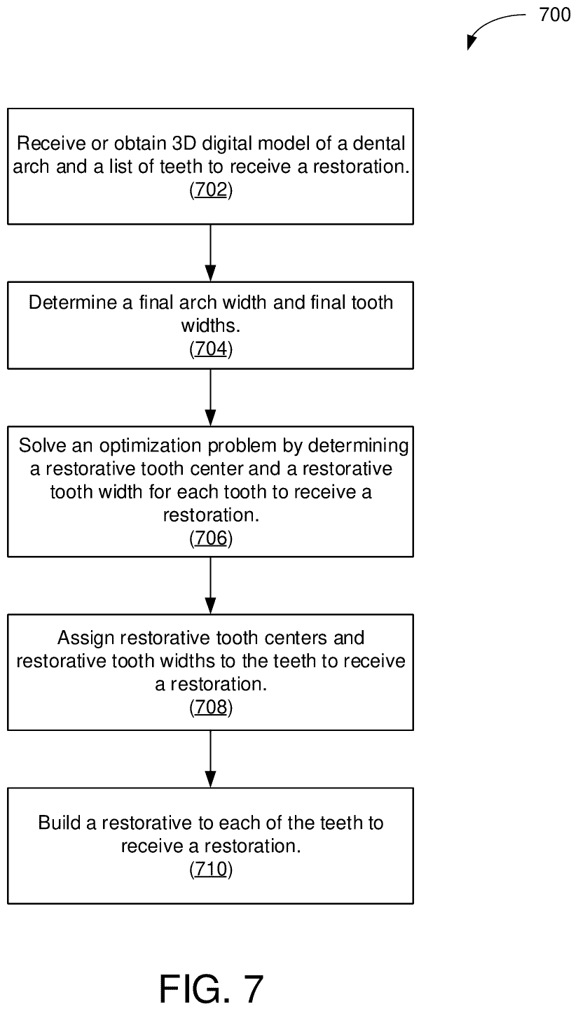

FIG. 7 is a flowchart showing another example method 700 for determining a width and/or location of a patient's restored teeth. The method 700 is described below with respect to the system 100 of FIG. 1 and/or the restorative width module 200 of FIG. 2, however, the method 700 may be performed by any other suitable system or device. The method begins in block 702 as a 3D digital model of a dental arch and a list of teeth to receive a restoration is received or obtained. For example, the restorative width module 200 can receive a 3D digital model of an upper or lower dental arch according to a dental treatment plan. Thus, the 3D digital model may be a simulation or prediction of a patient's dentition after performance of a dental treatment plan. In addition, the restorative width module 200 can receive a list of one or more teeth in the dental arch that are receiving a restoration treatment. In some examples, a user or clinician can indicate in a list the teeth that are to be restored.

Next, in block 704 the restorative width module 200 determines a final arch width and final tooth widths. For example, the restorative width module 200 can determine a final arch width of the patient's dental arch based on a simulation or a prediction based on a dental treatment plan. The restorative width module 200 can also determine one or more tooth widths for one or more teeth in the dental arch based on the dental treatment plan.

Next, in block 706 the restorative width module 200 solves an optimization problem by determining a restorative tooth center (restorative tooth position) and a restorative tooth width for each tooth to receive a restoration. Solving the optimization problem may include reviewing and/or modifying any number of parameters or features which may affect a position of the restored tooth (the restorative tooth center) and/or the width of the restored tooth.

For example, the optimization problem may determine tooth width and tooth position based on an amount of restorative overlap. The restorative overlay may refer to the amount of overlap between the restored tooth and any neighboring tooth. In another example, the optimization problem may determine tooth width and tooth position based on an amount of restorative contact. The restorative contact may describe any amount of contact between the restored tooth and any neighboring tooth. In yet another example, the optimization problem may determine tooth width and tooth position based on restorative symmetry. The restorative symmetry may describe how well each side of the dental arch matches the opposing side (the sides based on a dental midline of the dental arch).

In some aspects, the optimization problem may determine tooth width and tooth position based on desired interproximal spaces. The desired interproximal spaces may refer to spaces between restored and/or unrestored teeth. In some cases, the optimization problem may determine tooth width and tooth position based on a midline rule. Following a midline rule may cause tooth widths and/or tooth positions to be selected that are symmetric for teeth that border a target midline point.

In some aspects, the optimization problem may “weigh” one or more of the parameters or features described above. The “weighing” may place more emphasis on one or more characteristics, parameters, or features for the optimization problem. In some cases, the weighing may correspond to equation 1, described above.

Next, in block 708, the restorative width module 200 assigns restorative tooth centers and restorative tooth widths to teeth to receive a restoration based on the results of the solution to the optimization problem. Thus, based on the optimization problem set up and solved with respect to block 706, the restorative width module 200 can extract and in some cases export (to other programs or processing steps) the determined restorative tooth centers (e.g., the center of the restored tooth respect to the patient's dental arch) the restorative tooth widths.

Next, in block 710 the restorative width module 200 builds a restorative for each of the teeth in the dental arch to receive a restoration. In some examples, building the restorative may include outputting a digital model of the restorative. The digital model may include a restorative width, thickness, color, height, or the like. In some aspects, building a restorative may include generating one or more synthetic images of the restore teeth. In some cases, the synthetic images may include dental images of the entire dental arch.

In some examples, building the restorative may include outputting a specification file for each tooth to receive a restoration. The specification file may include any feasible parameter for building or constructing a restorative, including thickness, height, color, width, or the like.

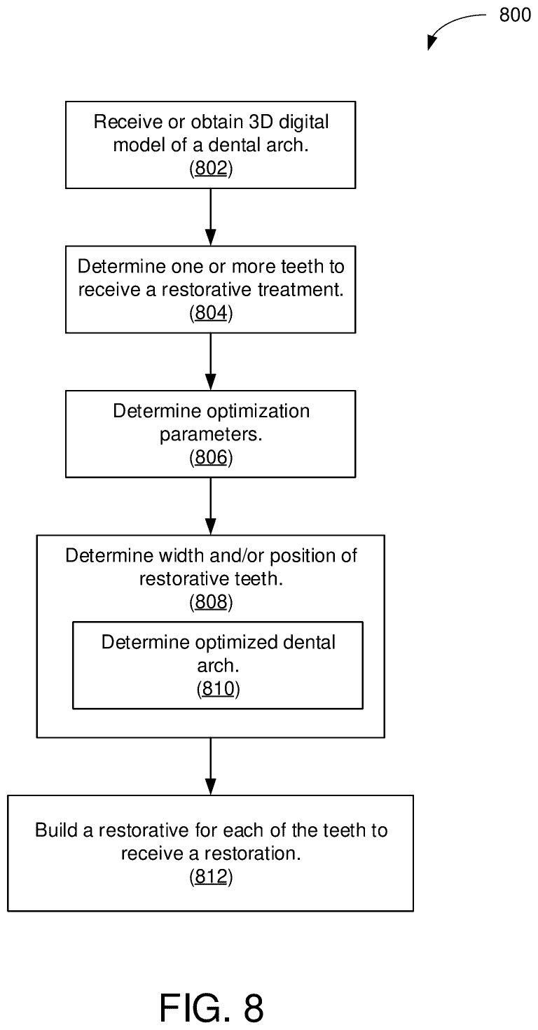

FIG. 8 is a flowchart showing another example method 800 for determining a width of a patient's restored teeth. The method 800 is described below with respect to the system 100 of FIG. 1 and/or the restorative width module 200 of FIG. 2, however, the method 800 may be performed by any other suitable system or device. The method begins in block 802 as a 3D digital model of a dental arch is received or obtained. For example, the restorative width module 200 can receive a 3D digital model of an upper or lower dental arch according to a dental treatment plan. Thus, the 3D digital model may be a simulation or prediction of a patient's dentition after performance of a dental treatment plan. In some examples, the 3D digital model may include tooth positions, a dental arch length, and tooth widths.

Next, in block 804 one or more teeth in the dental arch is determined to receive a restorative treatment. In some examples, a user or clinician can indicate which teeth within the dental arch will receive a planned restorative treatment. In some cases, the teeth to receive a restorative treatment may be placed on a list or stored in a file, database, or the like.

Next, in block 806 one or more optimization parameters are determined. As described herein, the optimization parameters may include allowable or desired tooth overlap, interproximal spaces, smile symmetry, midline rules or the like. In some examples, the optimization parameters can include information regarding the planned restorative treatment such as tooth shape, tooth location, restorative thickness and the like.

In some cases, the optimization parameters can include individual “weights” for one or more of the optimization parameters. In this manner, the importance of any one of the optimization parameters can be adjusted with respect to any other optimization parameter. The weights may be as described in Equation 1, above.

In some cases, the optimization parameters may include determining restoration information based at least in part on a restorative model that has been selected for a tooth that will receive a restorative treatment. The restorative model can include tooth shape, tooth width, restorative thickness, and the like. The restorative model can be selected from a database of one or more possible tooth shapes.

Next, in block 808 the widths and/or position of restorative teeth included in the dental arch are determined. In some aspects, the determination of the restorative widths and/or restorative tooth centers may include determining and solving a tooth width optimization of a dental arch 810. The optimization of the dental arch can include determining through a non-linear optimization operation the tooth widths of the various restored and non-restored teeth. In some examples, a location of centers of the restorative teeth may also be determined. The centers of the restorative teeth may determine tooth positions of the restorative teeth.

Next, in block 812, a restorative is built for each tooth to receive a restoration. In some examples, building the restorative may include outputting a digital model of the restorative. The digital model may include a restorative width, thickness, color, height, or the like. In some aspects, building a restorative may include generating one or more synthetic images of the restore teeth. In some cases, the synthetic images may include dental images of the entire dental arch. In some examples, building the restorative may include outputting a specification file for each tooth to receive a restoration. The specification file may include any feasible parameter for building or constructing a restorative, including thickness, height, color, width, or the like.

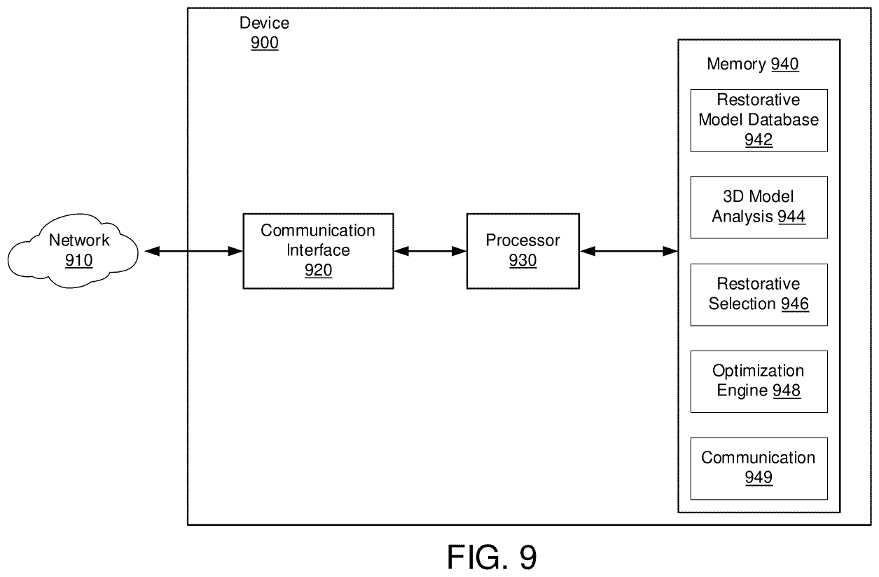

FIG. 9 shows a block diagram of a device 900 that may be one example a device configured to perform one or more operations associated with the computing environment 100 of FIG. 1. The device 900 may include a communication interface 920, a processor 930, and a memory 940.

The communication interface 920, which may be coupled to a network (such as a network 910) and to the processor 930, may transmit signals to and receive signals from other wired or wireless devices, including remote (e.g., cloud-based) storage devices, cameras, processors, compute nodes, processing nodes, computers, mobile devices (e.g., cellular phones, tablet computers and the like) and/or displays. For example, the communication interface 920 may include wired (e.g., serial, ethernet, or the like) and/or wireless (Bluetooth, Wi-Fi, cellular, or the like) transceivers that may communicate with any other feasible device through any feasible network. In some examples, the communication interface 920 may receive previous dental data, current dental data, dental treatment plans, and 3D dental models that are associated with a final position in accordance with a patient's dental treatment plan.

The processor 930, which is also coupled to the memory 940, may be any one or more suitable processors capable of executing scripts or instructions of one or more software programs stored in the device 900 (such as within memory 940).

The memory 940 may include a restorative model database 942 that may be used to locally store various models for restoratives that may be used in a restorative treatment. For example, the restorative model database 942 may include one or more restorative models that include different tooth shapes, thicknesses, tooth width, and the like. In some cases, the restorative models may be received through the communication interface 920 from remote servers, compute nodes, or the like.

The memory 940 may also include a non-transitory computer-readable storage medium (e.g., one or more nonvolatile memory elements, such as EPROM, EEPROM, Flash memory, a hard drive, etc.) that may store the following software modules: a 3D model analysis module 944 to determine tooth data from a 3D dental model of the patient's dentition; an restorative selection module 946 to determine which restorative model (stored in the restorative model database 942) is associated with any feasible teeth that are planned to receive a restorative treatment; and an optimization engine 948 to determine and solve an optimization to determine tooth widths of the patient's dentition; and a communication module 949 to transmit and receive data through the communication interface 920. Each software module includes program instructions that, when executed by the processor 930, may cause the device 900 to perform the corresponding function(s). Thus, the non-transitory computer-readable storage medium of memory 940 may include instructions for performing all or a portion of the operations described herein.

The processor 930 may execute the 3D analysis module 944 to determine and/or extract tooth data from a 3D dental model. For example, execution of the 3D analysis module 944 may obtain or receive a 3D dental models corresponding to a final position based on a dental treatment plan. In some examples, the 3D analysis module 944 can determine tooth location, tooth width, dental arch length, and tooth spaces. In some other examples, other tooth data may be determined.

The processor 930 may execute the restorative selection module 946 to determine which restoration model may be associated with teeth planned to receive a restorative treatment. Execution of the restoration selection module 946 may include selecting a model from the restorative model database 942 for one or more of the teeth to receive a restorative treatment.

The processor 930 may execute the optimization engine 948 to determine and optimize tooth widths for teeth in a dental arch. For example, execution of the optimization engine 948 may determine values of various optimization parameters for determining tooth widths. In some examples, execution of the optimization engine 948 may perform a non-linear optimization to determine the tooth widths of the various restored and non-restored teeth. In some examples, a location of centers of the restorative teeth may also be determined. The centers of the restorative teeth may determine tooth positions of the restorative teeth.

Execution of the optimization engine 948 can solve an optimization problem by determining a restorative tooth center and a restorative tooth width for each tooth to receive a restoration. As described herein, solving the optimization problem may include reviewing and/or modifying any number of parameters or features which may affect a position of the restored tooth (the restorative tooth center) and/or the width of the restored tooth.

In some aspects, execution of the optimization engine 948 can build a restorative for each of the teeth in the dental arch to receive a restoration. Building the restorative may include outputting a digital model of the restorative. The digital model may include a restorative width, thickness, color, height, or the like. In some aspects, building a restorative may include generating one or more synthetic images of the restore teeth. In some cases, the synthetic images may include dental images of the entire dental arch. Building the restorative may include outputting a specification file for each tooth to receive a restoration. The specification file may include any feasible parameter for building or constructing a restorative, including thickness, height, color, width, or the like.

The processor 930 may execute the communication module 949 to communicate with any other feasible devices. For example, execution of the communication module 949 may enable the device 900 to communicate via cellular networks conforming to any of the LTE standards promulgated by the 3^{rd} Generation Partnership Project (3GPP) working group, Wi-Fi networks conforming to any of the IEEE 802.11 standards, Bluetooth protocols set forth by the Bluetooth Special Interest Group (SIG), Ethernet protocols, or the like. In some embodiments, execution of the communication module 949 may enable the device 900 to communicate with cloud-based servers, network coupled displays, or other computer devices and/or user interfaces. In some other embodiments, execution of the communication module 949 may implement encryption and/or decryption procedures.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An apparatus, comprising:
a processor; and
a memory that includes instructions, which when executed, cause the processor to:
access or receive a final position three-dimensional (3D) digital dental model based on a dental treatment plan, and a list of one or more teeth that are to receive a restorative treatment;
determine a final arch width and a plurality of final tooth widths from the final position 3D digital dental model;
compute to solve an optimization problem by determining a restorative tooth center and a restorative tooth width for each of the one or more teeth in the list of one or more teeth to receive a restorative in which a solution to the optimization problem optimizes for at least: a restorative overlap, a restorative contact, and a restorative symmetry; and
assign the restorative tooth center and the restorative tooth width to the restorative for each of the one or more teeth in the list of one or more teeth to receive the restorative.

2. The apparatus of claim 1, wherein the restorative overlap comprises coverage of the restorative over each of the one or more teeth to receive the restorative.

3. The apparatus of claim 1, wherein the restorative contact comprises contact between the restorative and neighboring teeth and/or neighboring restoratives.

4. The apparatus of claim 1, wherein the restorative symmetry comprises symmetry between the restorative and one or more teeth of a same type as the tooth receiving the restorative in the final position 3D digital dental model.

5. The apparatus of claim 1, wherein the instructions are further configured to cause the processor to display, in a user interface, the final position 3D digital dental model including the restorative for each of the one or more teeth in the list of one or more teeth to receive a restorative and receiving one or more user modifications thereto, and adjusting the restorative according to the one or more user modifications thereto.

6. The apparatus of claim 1, wherein the instructions are further configured to build the restorative for each of the one or more teeth in the list of one or more teeth to receive a restorative.

7. The apparatus of claim 1, wherein the instructions are further configured to cause the processor to build the restorative by outputting a digital model of the restorative for each of the one or more teeth in the list of one or more teeth to receive a restorative, and one or more synthetic images of the final position 3D digital dental model including the restorative for each of the one or more teeth in the list of one or more teeth to receive the restorative.

8. The apparatus of claim 1, wherein the instructions are further configured to cause the processor to build the restorative by outputting a specifications file including measurements for the restorative for each of the one or more teeth in the list of one or more teeth to receive the restorative.

9. The apparatus of claim 1, wherein the instructions are further configured to receive a restorative model for at least one of the one or more teeth in the list of one or more teeth to receive the restorative, and wherein the instructions are further configured to cause the processor to optimize the optimization problem using the restorative model.

10. The apparatus of claim 1, wherein the instructions are further configured to compute to solve the optimization problem using weights for each of the restorative overlap, the restorative contact, and the restorative symmetry.

11. The apparatus of claim 10, wherein the instructions are further configured to receive from a user interface, weights for one or more of the restorative overlap, a restorative contact, and a restorative symmetry from a user.

12. The apparatus of claim 1, wherein the instructions are further configured to compute to solve the optimization problem in which the optimization problem also optimizes for a midline rule, wherein tooth widths for central teeth borders a target midline point.

13. The apparatus of claim 1, wherein the instructions are further configured to compute to solve the optimization problem in which the restorative overlap includes a range of interproximal spaces between teeth.

14. An apparatus, comprising:
a processor; and
a memory that includes instructions, which when executed, cause the processor to:
access or receive a final position three-dimensional (3D) digital dental model based on a dental treatment plan, and a list of one or more teeth that are to receive a restorative treatment;
determine a final arch width and a plurality of final tooth widths from the final position 3D digital dental model;
compute to solve an optimization problem by determining a restorative tooth center and a restorative tooth width for each of the one or more teeth in the list of one or more teeth to receive a restorative in which a solution to the optimization problem optimizes for at least: restorative overlap comprising coverage of the restorative over each of the one or more teeth to receive the restorative, restorative contact comprising contact between the restorative and neighboring teeth and/or neighboring restoratives, and restorative symmetry comprising symmetry between the restorative and one or more teeth of a same type as the tooth receiving the restorative in the final position 3D digital dental model;
assign the restorative tooth center and the restorative tooth width to the restorative for each of the one or more teeth in the list of one or more teeth to receive the restorative; and
building the restorative for each of the one or more teeth in the list of one or more teeth to receive a restorative.

15. An apparatus, comprising:
a processor configured to:
access or receive a final position dental model based on a dental treatment plan;
determine dental information based on the final position dental model;
access or receive a list of one or more teeth to receive a restorative treatment;
access or receive one or more optimization targets;
optimize widths and locations of teeth on the list of one or more teeth based on the dental information, the list of one or more teeth, and one or more optimization targets; and
assign restorative widths and locations of teeth on the list of one or more teeth based on the optimized widths and locations.

16. The apparatus of claim 15, wherein the dental information includes tooth widths, dental arch length, tooth positions with respect to a dental arch, or a combination thereof.

17. The apparatus of claim 15, wherein the one or more optimization targets include a user selection of a restorative model for use with at least one tooth on the list of teeth.

18. The apparatus of claim 15, wherein the restorative widths are based on weighted optimization targets, wherein weights of the optimization targets are determined by a user.

19. The apparatus of claim 15, wherein the restorative widths are based at least in part on mesial-to-distal tooth widths and interproximal spaces included in the dental information.

20. The apparatus of claim 15, wherein the one or more optimization targets include a planned length of a dental arch in accordance with the dental treatment plan.

21. The apparatus of claim 15, wherein the one or more optimization targets include a tooth symmetry target, wherein tooth widths of contralateral teeth are selected to be similar.

22. The apparatus of claim 15, wherein the processor is further configured to render a 3D digital model of a dental arch based the restorative widths and locations of teeth on the list of one or more teeth.

23. The apparatus of claim 15, wherein the one or more optimization targets include a range of acceptable interproximal spaces between teeth.

24. The apparatus of claim 15, wherein the one or more optimization targets include an amount of overlap between two or more teeth.
